(19) United States
(12) Patent Application Publication
(10) Pub. No.: US 2002/0066163 A1
(43) Pub. Date: Jun. 6, 2002

(54) Ergonomic handle

(76) Inventor: Michael M. Lomax, Erie, PA (US)

Correspondence Address: RICHARD K THOMSON, ATTORNEY, 7691 FAIRLANE DRIVE, FAIRVIEW, PA, 16415

(21) Appl. No.: 09/730,057

(22) Filed: Dec. 5, 2000

(51) Int. Cl. E05B 1/00

(52) U.S. Cl. 16/430

(57) ABSTRACT

An ergonomic handle with a grippable portion canted at an angle of between 37° and 50° to better accommodate a natural disposition of a wrist and finger grip of a user. The article with which this handle is used has a first handle portion with a conventional orientation to the article, the second grippable portion and a third handle portion which attaches the second handle portion to the first handle portion. The second and third handle portions form an isosceles triangle with the axis of the first handle portion. In most applications, the first handle portion has an extension which encloses the third side of the isosceles triangle for strength and stability. Applications include sporting goods, tools, and housewares.

### BACKGROUND AND SUMMARY OF THE INVENTION

The present invention is directed to an improved handle design useful in a variety of applications. More particularly, the present invention is directed to an ergonomic handle to better accommodate a natural disposition of a wrist and finger grip of a user.

Conventional handles on athletic equipment, tools, and housewares have a conventional orientation relative to a particular item, that is, either perpendicular to or in general alignment with the item. These handles tend to be straight requiring the hand/wrist to be flexed almost 90° from its at rest position. This is generally not the optimum arrangement for hand and wrist to do the work asked of them. It unduly stresses certain muscle groups while underutilizing others. It is the intention of the present invention to provide a more ergonomically conscious handle.

A number of patents have sought to address this problem. For example, U.S. Pat. No. 4,147,348 to Lee describes a tennis racket designed to enable the player to hit more powerful shots while reducing torsional forces. Lee proposes to tilt the handle grip at an angle of 32°±4° relative to the shaft of the racket and the head 5° upwardly. This patent comes close to providing an acceptable ergonomic handle; however, the angle selected is not the optimum angle for best hand and wrist alignment. In addition, the configuration will likely cause problems in controlling the head of the racket, particularly as it relates to stopping the momentum after striking the ball.

U.S. Pat. No. 5,802,960 issued to Graj et al. seeks to overcome the faulty hand and wrist alignment of conventional handles on cookware by providing a forearm brace and an upwardly extending graspable portion. This proposed solution does not actually eliminate the difficulties of the hand and wrist misaligmnent haunting conventional handles but tries to lessen those difficulties. The resulting solution is awkward and results in a pan which provides storage problems since such a pan would not be readily stackable.

U.S. Pat. No. 5,771,535 issued to Blessing describes a handle for a rake, or the like, which has angulated gripping portions, some angular some perpendicular, allegedly to provide ergonomic gripping positions to relieve stress and fatigue. In addition, Blessing proposes to make a portion of his handle adjustable relative to the rest for additional versatility. The inventor is ever so close to recognizing the problem and to providing a viable solution. As it is, the proposed handle is simply gangly and difficult to manufacture.

Stanish teaches the use of an ergonomic handle which bends the gripping angle 26-34° out of, in some applications, a horizontal plane, in others, a vertical plane, in yet others, a combined compound angle including a 30° rotation about the axis. This is a well reasoned approach; nonetheless the resulting solution is complicated and the proposed angles are just short of optimum.

Backich et al. discloses an ergonomic scoop design in which the handle is positioned at an angle of 115-135° from the axis of the user's arm (25-35° from vertical). The handle includes an arm brace which transfers a portion of the load/stress to the user's forearm. Here again, the angle is short of optimum and the use of an arm brace is not attractive for many applications.

The present invention provides an ergonomic handle useful for applications including sports equipment, tools and household utensils. The ergonomic handle of the present invention includes a) a first handle portion having a first axis oriented in a conventional orientation relative to the primary axis of the item; b) a second handle portion having a second axis canted relative to said first axis by an angle a falling in the range of between 37° and 50° to better accommodate a natural disposition of a wrist and finger grip of a user. This angle will a) put the muscles of the upper forearm and lower forearm in equal tension, and b) substantially equalize the gripping force of all four finger flexors.

A third handle portion will typically be used to connect the grippable handle portion to the first handle portion. The first and second handle portions preferably define an isosceles triangle with the axis of the first handle portion. The first handle portion may, in fact, have an extension which closes the triangle or, if the material is sufficiently sturdy to accommodate the forces which the item will see in normal use without undue flexing, the third side may remain open. For most applications, it is preferred that the first side close the isosceles triangle to provide the strength and rigidity that most of the proposed applications will require.

Various other features, advantages and characteristics of the present invention will become apparent to one of ordinary skill in the art after a reading of the following specification.

### BRIEF DESCRIPTION OF THE DRAWINGS

The preferred embodiment(s) of the present invention is/are described in conjunction with the associated drawings in which like features are indicated with like reference numerals and in which

FIG. 1 is a side view of a first embodiment of the ergonomic handle of the present invention;

FIG. 2 is a top view of a tennis racket equipped with the ergonomic handle of the present invention;

FIG. 3 is a top view of a table tennis paddle equipped with the ergonomic handle of the present invention;

FIG. 4A is a side view of a first embodiment of a putter employing the features of the present invention;

FIG. 4B is a side view of a second embodiment of a putter employing the features of the present invention;

FIG. 5A is a side view of a first embodiment of a snow shovel employing the features of the present invention;

FIG. 5B is a side view of a second embodiment of a snow shovel employing the features of the present invention;

FIG. 6 is a side view of a hockey stick employing the principles of the present invention;

FIG. 7 is a side view of a kitchen utensil employing the principles of the present invention;

FIG. 8A is a front view of one half of a ratchet mechanism permitting limited angular movement of the type desired with the present invention; and

FIG. 8B is a front view of the face of the second half of the ratchet mechanism.

### DETAILED DESCRIPTION OF PREFERRED EMBODIMENT(S)

The ergonomic handle of the present invention is depicted in FIG. 1 generally at 20. This ergonomic handle 20 can be used with sporting goods, such as tennis rackets, golf clubs, table tennis paddles, hockey sticks (field and ice), racket ball rackets, and the like; tools, such as shovels including snow shovels, hammers, power tools, and the like; housewares such as kitchen utensils including pots and pans, hand-held appliances, and the like. The article will have a primary axis and a first handle portion 11 with a first axis that forms a conventional angle with the article's primary axis. In the case of a tennis racket 15 (FIG. 2) for example, first handle portion 11 will be aligned with the primary axis of the racket 15. In the case of a hockey stick 17 (FIG. 6) or a golf putter head 19 (FIGS. 4A and 4B), the first handle portion 11 will form generally a right angle or lie perpendicular to, the primary axis of the item.

Second handle portion 22 has a second axis which forms an angle α with the first axis of the first handle portion 11. Angle α should lie in the range of between 37-50° and, most preferably 45°.

This angle will a) put the muscles of the upper forearm and lower forearm in equal tension, and b) substantially equalize the gripping force of all four finger flexors. This provides a more natural disposition for the hand and wrist permitting optimum power to be administered to the item while minimizing the buildup of stress in the muscles. In applications where gripping is particularly important, second handle portion 22 can be formed with finger grips 23.

For most applications, a third handle portion 24 will interconnect second handle portion 22 to first handle portion 11. Third handle portion 24 will form an angle β with the first axis of the first handle portion 11 and define an isosceles triangle, the lengths of second handle portion 22 and third handle portion 24 being the same with α and β being equal. In the most preferred configuration, a and β are each equal to 45° and the included angle between second handle portion 22 and third handle portion 24 will be 90°. Further, for most applications in which added strength is needed to prevent flexing of the second handle portion 22 relative to the third handle portion 24, an extension 11e of first handle portion 11 will close off the third side of the isosceles triangle 26. For those applications where the additional strength is not needed, either because of the particulars of the usage and/or the material of which the second and third handle portions 22 and 24 are made is rigid/strong enough, enclosing the third side of the isosceles triangle will be unnecessary.

FIG. 2 shows the tennis racket 15 equipped with the ergonomic handle 20 of the present invention. The finger grips 23 in conjunction with the contact of the player's index finger with second handle portion 22 and pinky finger with first handle portion extension lie permit control of the head momentum of the racket, thereby overcoming the problem which attended the design of the Lee racket.

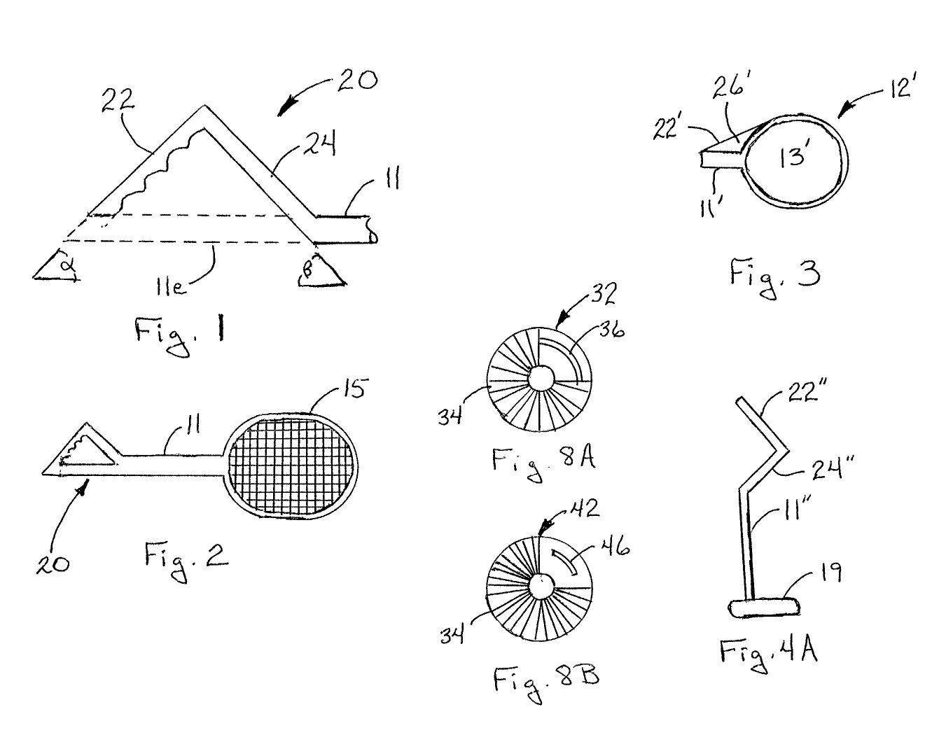

FIG. 3 shows a table tennis paddle 12′ equipped with isosceles triangular portion 26′ extending from handle 11′ and the edge of paddle face 13′. Most advanced table tennis players overlap their fingers across the paddle face 13′ to provide increased control. In doing so, they place their fingers across a portion of the striking surface risking contact with the ball and loss of a point. The triangular portion 26′ will actually be an extension of the paddle face 13′ having its thickness yet, will provide a grippable surface which will not significantly decrease the striking area of the paddle 12′.

FIGS. 4A and 4B depict to embodiments of golf clubs, specifically putters 12″. Currently, the rules of golf do not permit deviations in the shaft from straight (USGA Rule 4-1.b). However, it is envisioned that as the ISOSCELES GRIP (trademark) of the present invention catches on in other applications, it will produce a revolution that will result in this rule being changed. In the embodiment of FIG. 4A, first handle portion 11″ is connected to club head 19 in a conventional orientation, generally perpendicular to the primary axis of the club head 19. It will be understood that “generally perpendicular” will be understood to include forming an angle of up to 15° with the club head 19 as is conventional in the industry. Second handle portion 22″ is connected to first handle portion 11″ by third handle portion 24″ and is of sufficient length to accommodate both the player's hands. In addition to providing a superior hand and wrist angle for the golfer, this putter 12″ will permit most golfers to stand more erect and still have their eyes directly above the ball and target line improving overall scoring. The second embodiment of FIG. 4B includes a fourth handle portion 28′″ positioned at an angle α′″ relative to the first axis of first handle portion 11′″ and a fifth handle portion 30′″ positioned at an angle β′″ relative to the first axis of first handle portion 11′″ in addition to second handle portion 22′″ and third handle portion 24′″ at angles α and β respectively. Preferably, α′″ equals α and β′″ equals β. This design has the advantages of that of FIG. 4A while accommodating larger spacing between the golfer's hands preferred by some. The application and materials typically used in manufacture of club shafts do not require that the isosceles triangle be enclosed on putters of FIGS. 4A and 4B.

In those applications where enclosure is unnecessary, additional flexibility can be afforded the article with which the handle of the present invention is used by making the angle α adjustable. Such adjustment capability could be provided by a ratchet of the type shown in FIGS. 8A and 8B generally at 32 and 42. Ratchet 32 has a conventional ratchet tooth pattern over ¾ of its face 34. The other ¼ of face 34 is recessed and has a groove 36 extending over its entire angular extent. Ratchet 42 similarly has ratchet teeth over ¾ of its face 44. Positioned on the other ¼ of face 44 is a arcuate projection 46 which is to be received within groove 36. The angular extent of projection 46 is 77° allowing a relative rotation between ratchet face 34 and 44 of 13°. By positioning ratchet 32 on a first one of handle portions 22 and 24, and ratchet 42 on the other in an appropriate orientation, this ratchet can limit the angular adjustment of second handle portion 22 relative to third handle portion 24 between 37° and 50°. This enables the individual user to position the second handle portion at the specific angle within the desired range which they find to be best for them. Should ratchet faces 34 and 44 become misaligned to the point that projection 46 on face 44 is engaging the ratchet teeth on face 34, no amount of tightening of the nut onto the screw interconnecting ratchet portions 32 and 42 will enable the ratchet halves to sustain the handle portions 22 and 24 in a desired relationship. Projection 46 must be engaged in groove 36 for the ratchet to operate properly.

FIGS. 5A and 5B depict two embodiments of the ergonomic handle 20 of the present invention utilized in a shovel, specifically, a snow shovel 14. The preferred embodiment is shown in FIG. 5A in which the isosceles triangle formed by the axis of second handle portion 22^{iv} and the axis of third handle portion 24^{iv} with the axis of first handle portion 11^{iv} is filled in by first handle portion extension 11e^{iv}. Similarly, a grip for the user's second hand is formed by a fourth handle portion 28^{iv} and fifth handle portion 30^{iv} which is similarly enclosed. Enclosure of the ISOSCELES GRIP handle is preferred in order to avoid bending of handle 11^{iv} under loads of snow and ice being removed by the shovel 14. It is, however, contemplated that certain materials would have adequate strength to permit the use of open triangles 26U and 26L as depicted in FIG. 5B.

FIG. 6 shows the handle 20^{vi} being used on a hockey stick 17. The spacing between upper isosceles triangle 26U′ and lower isosceles triangle 26L′ may be varied to accommodate the preferences of the ice hockey or field hockey player for which it is made. There is no rule or restriction within the regulations governing ice hockey equipment that would preclude the use of the ergonomic handle of the present invention from being used and the advantages associated with the ISOSCELES GRIP handle of the present invention would warrant its inclusion.

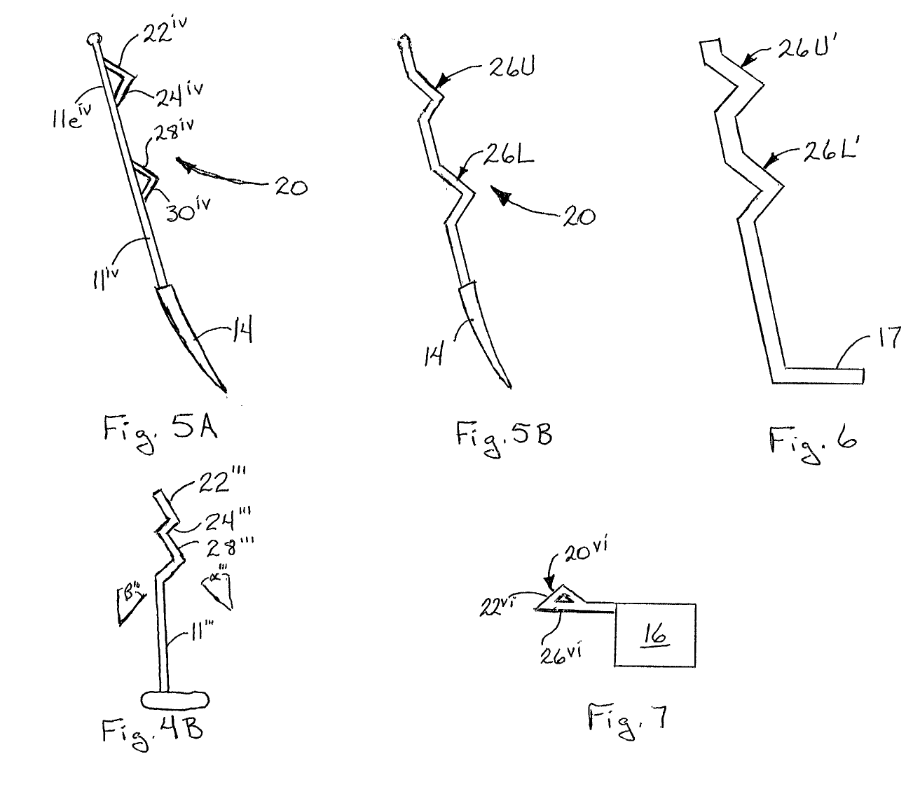

FIG. 7 depicts handle 20^{vii} being used on a houseware, namely a kitchen utensil in the form of cookware 16. Isosceles triangle 26^{vii} is closed to avoid flexing of the second handle portion 22^{vii}. The risks associated with such flexing of cookware containing boiling hot liquids is too great to even contemplate the use of an open-sided triangle. Accordingly, all cookware 16 should be equipped with the closed-sided triangular handle 20^{vii} shown here.

The ergonomic handle 20 of the present invention provides a grippable second handle portion whose axis forms an angle α with the axis of the first handle portion which itself forms a conventional orientation with respect to the item to which it is attached. The angle α falls in the range of between 37° and 50°. Generally, the second handle portion will be attached to the first handle portion by a third handle portion which forms an angle β with the axis of the first handle portion, the lengths of second and third handle portions being generally equal and the angle β generally being equal to a so that second and third handle portions form an isosceles triangle with the axis of the first handle portion. It is preferred that the third side of the triangle be enclosed by an extension of first handle portion; however, for certain applications and certain materials, this added structure may be eliminated.

Various changes, alternatives and modifications will become apparent to one of ordinary skill in the art following a reading of the foregoing specification. It is intended that any such changes, alternatives and modifications as fall within the scope of the appended claims be considered part of the present invention.

I claim:

1. An ergonomic handle for a group of items consisting of athletic equipment, tools, and housewares, each item having a primary axis, said ergonomic handle comprising
a) a first handle portion having a first axis oriented in a conventional orientation relative to the primary axis of the item;
b) at least one second grippable handle portion having a second axis canted relative to the first axis by an angle a falling in the range of between 37° and 50° to better accommodate a natural disposition of a wrist and finger grip of a user.

2. The ergonomic handle of claim 1 wherein α is 45°.

3. The ergonomic handle of claim 1 wherein the first axis is coaxial with the primary axis of the item.

4. The ergonomic handle of claim 1 wherein the first axis is perpendicular to the primary axis of the item.

5. The ergonomic handle of claim 1 further comprising means to adjust said angle α between the lower and upper range thereof.

6. The ergonomic handle of claim 1 further comprising at least one third handle portion having a third axis canted relative to the first axis of the first handle portion by an angle β and having a portion of said at least one third handle portion connected to the first handle portion, said second and third handle portions forming an isosceles triangle with the first axis of the first handle portion.

7. The ergonomic handle of claim 6 wherein said angles α and β are equal angles.

8. In an item of athletic equipment having a primary axis and a first handle portion having a first axis with a conventional orientation to the item, the improvement comprising:
at least one second grippable ergonomic handle portion which forms an angle α with the first axis of the first handle portion, said angle α lying in a range of between 37° and 50° to better accommodate a natural disposition of a wrist and finger grip of a user.

9. The item of athletic equipment of claim 8 wherein said item is a table tennis paddle including a paddle with a first thickness and said primary handle which has a second larger thickness, said at least one second handle portion having the thickness of said paddle.

10. The item of athletic equipment of claim 8 further comprising at least one third handle portion which forms an angle β with the first handle portion and connects said second handle portion to the first handle portion, said second and third handle portions forming an isosceles triangle with the axis of the first handle portion.

11. The item of athletic equipment of claim 10 wherein said item is a tennis racket and said second handle portion includes a finger grip to enhance racket control.

12. The item of athletic equipment of claim 10 wherein said item is a putter and said at least one second handle portion is of sufficient length to accommodate both hands.

13. The item of athletic equipment of claim 10 wherein said item is a putter and said at least one second handle portion includes two separate portions, a first second handle portion to accommodate a first hand, and a fourth handle portion, which is a second said second handle portion, positioned below said third handle portion, said fourth handle portion forming an angle α′ with the axis of the first handle portion, said angle α′ lying in a range of between 37° and 50° to better accommodate a natural disposition of a wrist and finger grip of a second hand of the user.

14. A tool having a primary axis and a first primary handle portion having a first axis which has a conventional orientation to the item, the improvement comprising:
at least one second grippable ergonomic handle portion which forms an angle α with the first handle portion, said angle α lying in a range of between 37° and 50° to better accommodate a natural disposition of a wrist and finger grip of a user.

15. The tool of claim 14 further comprising at least one third handle portion which forms an angle β with the first handle portion, said second and third handle portions forming an isosceles triangle with the first handle portion.

16. The tool of claim 15 wherein said at least one second handle portion and said at least one third handle portion are axially aligned with and overlie the first handle portion.

17. The tool of claim 16 further comprising a fourth handle portion, which is a second of said at least one second handle portions, having an axis which forms an angle α′ with the axis of the first handle portion and a fifth handle portion, which is a second of said at least one third handle portions, having an axis which forms an angle β′ with the axis of the first handle portion, said fourth and fifth handle portions accommodating gripping by a second hand.

18. In a household item having a primary axis and a first handle portion with a conventional orientation to the item, the improvement comprising:
a second at least one grippable ergonomic handle portion which forms an angle α with the first handle portion, said angle α lying in a range of between 37° and 50° to better accommodate a natural disposition of a wrist and finger grip of a user.

19. The household item of claim 18 further comprising at least one third handle portion which forms an angle β with the first handle portion, said second and third handle portions forming an isosceles triangle with the first handle portion.

20. The household item of claim 19 wherein said household item comprises a cooking utensil.
